(19) United States
(12) Patent Application Publication
(10) Pub. No.: US 2014/0176592 A1
(43) Pub. Date: Jun. 26, 2014

(54) CONFIGURING TWO-DIMENSIONAL IMAGE PROCESSING BASED ON LIGHT-FIELD PARAMETERS

(71) Applicant: Lytro, Inc., Mountain View, CA (US)

(72) Inventors: Bennett Wilburn, Mountain View, CA (US); Tony Yip Pang Poon, Fremont, CA (US); Colvin Pitts, Snohomish, WA (US); Chia-Kai Liang, Mountain View, CA (US); Timothy Knight, Palo Alto, CA (US); Robert Carroll, San Francisco, CA (US)

(73) Assignee: Lytro, Inc., Mountain View, CA (US)

(21) Appl. No.: 14/051,263

(22) Filed: Oct. 10, 2013

Related U.S. Application Data
(63) Continuation-in-part of application No. 13/027,946, filed on Feb. 15, 2011.
(60) Provisional application No. 61/715,297, filed on Oct. 18, 2012.

(51) Int. Cl. G09G 5/10

(52) U.S. Cl. CPC G09G 5/10
USPC 345/589

(57) ABSTRACT

According to various embodiments, the present may be used to apply a wide variety of processes to a two-dimensional image generated from light-field data. One or more parameters, such as light-field parameters and/or device capture parameters may be included in metadata of the two-dimensional image, and may be retrieved and processed to determine the appropriate value(s) of a first setting of the process. The process may be applied uniformly, or with variation across subsets of the two-dimensional image, down to individual pixels. The process may be a noise filtering process, an image sharpening process, a color adjustment process, a tone curve process, a contrast adjustment process, a saturation adjustment process, a gamma adjustment process, a combination thereof, or any other known process that may be desirable for enhancing two-dimensional images.

### CROSS-REFERENCE TO RELATED APPLICATIONS

The present application claims priority from U.S. Provisional Application Ser. No. 61/715,297 for “Configuring Two-Dimensional Image Processing Based on Light-Field Parameters” (Atty. Docket No. LYT093-PROV), filed on Oct. 18, 2012, the disclosure of which is incorporated herein by reference in its entirety.

The present application further claims priority as a continuation-in-part of U.S. Utility application Ser. No. 13/027,946 for “3D Light Field Cameras, Images and Files, and Methods of Using, Operating, Processing and Viewing Same” (Atty. Docket No. LYT3006), filed on Feb. 25, 2011, the disclosure of which is incorporated herein by reference in its entirety.

The present application is related to U.S. Utility application Ser. No. 11/948,901 for “Interactive Refocusing of Electronic Images” (Atty. Docket No. LYT3000), filed on Nov. 30, 2007, the disclosure of which is incorporated herein by reference in its entirety.

The present application is related to U.S. Utility application Ser. No. 12/703,367 for “Light-field Camera Image, File and Configuration Data, and Method of Using, Storing and Communicating Same” (Atty. Docket No. LYT3003), filed on Feb. 10, 2010, the disclosure of which is incorporated herein by reference in its entirety.

The present application is related to U.S. Utility application Ser. No. 13/664,938 for “Light-field Camera Image, File and Configuration Data, and Method of Using, Storing and Communicating Same” (Atty. Docket No. LYT3003CONT), filed on Oct. 31, 2012, the disclosure of which is incorporated herein by reference in its entirety.

The present application is related to U.S. Provisional application Ser. No. 13/688,026 for “Extended Depth of Field and Variable Center of Perspective in Light-Field Processing” (Atty. Docket No. LYT003), filed on Nov. 28, 2012, the disclosure of which is incorporated herein by reference in its entirety.

### FIELD OF THE INVENTION

The present invention relates to systems and methods for processing and displaying light-field image data.

### SUMMARY

According to various embodiments, the system and method of the present invention provide mechanisms for configuring two-dimensional (2D) image processing performed on an image or set of images. More specifically, the two-dimensional image processing may be configured based on parameters derived from the light-field and/or parameters describing the picture being generated from the light-field.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1A depicts an example of an architecture for implementing the present invention in a light-field capture device, according to one embodiment.

FIG. 1B depicts an example of an architecture for implementing the present invention in a post-processing system communicatively coupled to a light-field capture device, according to one embodiment.

FIG. 2 depicts an example of an architecture for a light-field camera for implementing the present invention according to one embodiment.

FIG. 3 depicts a portion of a light-field image.

FIG. 4 depicts transmission of light rays through a microlens to illuminate pixels in a digital sensor.

FIG. 5 depicts an arrangement of a light-field capture device wherein a microlens array is positioned such that images of a main-lens aperture, as projected onto the digital sensor, do not overlap.

FIG. 6 depicts an example of projection and reconstruction to reduce a four-dimensional light-field representation to a two-dimensional image.

FIG. 7 depicts an example of a system for implementing the present invention according to one embodiment.

FIG. 8 illustrates a method for utilizing parameters pertinent to a two-dimensional image captured from light-field data in the application of a process on the two-dimensional image.

FIG. 9 illustrates an example of how the settings for a reconstruction filter and an unsharp mask may be selected, according to one embodiment of the invention.

FIG. 10 illustrates a more specific version of the method of FIG. 8, with application to an unsharp mask to be applied to the two-dimensional image according to one embodiment of the invention.

FIG. 11 illustrates an example of how a vignetting lens effect may be applied according to one embodiment of the invention.

### DETAILED DESCRIPTION

### Definitions

For purposes of the description provided herein, the following definitions are used:
Anterior Nodal Point: the nodal point on the scene side of a lens.
Bayer Pattern: a particular 2×2 pattern of different color filters above pixels on a digital sensor. The filter pattern is 50% green, 25% red and 25% blue.
Center Of Perspective: relative to a scene being photographed, the center of perspective is the point (or locus of points) where light is being captured. Relative to the camera's sensor image, it is the point (or locus of points) from which light is being emitted to the sensor. For a pinhole camera, the pinhole is the center of perspective for both the scene and the sensor image. For a camera with a more complex main lens, the scene-relative center of perspective may be best approximated as either the anterior nodal point of the main lens, or the center of its entrance pupil, and the sensor-relative center of perspective may be best approximated as either the posterior nodal point of the main lens, or as the center of its exit pupil.
CoP: abbreviation for center of perspective.
Disk: a region in a light-field image that is illuminated by light passing through a single microlens; may be circular or any other suitable shape.
Entrance Pupil: the image of the aperture of a lens, viewed from the side of the lens that faces the scene.
Exit Pupil: the image of the aperture of a lens, viewed from the side of the lens that faces the image.
Frame: a data entity (stored, for example, in a file) containing a description of the state corresponding to a single captured sensor exposure in a camera. This state may include the sensor image and/or other relevant camera parameters, which may be specified as metadata. The sensor image may be either a raw image or a compressed representation of the raw image.
Image: a two-dimensional array of pixel values, or pixels, each specifying a color.
Lambda (also referred to as “depth”): a measure of distance perpendicular to the primary surface of the microlens array. In at least one embodiment, one lambda may correspond to the gap height between the image sensor and the microlens array (MLA), with lambda=0 being at the MLA plane.
Light-field: a collection of rays. A ray's direction specifies a path taken by light, and its color specifies the radiance of light following that path.
Light-field image: a two-dimensional image that spatially encodes a four-dimensional light-field. The sensor image from a light-field camera is a light-field image.
Microlens: a small lens, typically one in an array of similar microlenses.
MLA: abbreviation for microlens array.
Nodal Point: the center of a radially symmetric thin lens. For a lens that cannot be treated as thin, one of two points that together act as thin-lens centers, in that any ray that enters one point exits the other along a parallel path.
Picture: a data entity (stored, for example, in a file) containing one or more frames, metadata, and/or data derived from the frames and/or metadata. Metadata can include tags, edit lists, and/or any other descriptive information or state associated with a picture or frame.
Pixel: an n-tuple of intensity values, with an implied meaning for each value. A typical 3-tuple pixel format is RGB, wherein the first value is red intensity, the second green intensity, and the third blue intensity. Also refers to an individual sensor element for capturing data for a pixel.
Posterior Nodal Point: the nodal point on the image side of a lens.
Representative Ray: a single ray that represents all the rays that reach a pixel.
Two-dimensional image (or image): a two-dimensional array of pixels, each specifying a color. The pixels are typically arranged in a square or rectangular Cartesian pattern, but other patterns are possible.
Two-dimensional image processing: any type of changes that may be performed on a two-dimensional image.
Vignetting: a phenomenon, related to modulation, in which an image's brightness or saturation is reduced at the periphery as compared to the image center.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art, are disclosed herein, or could be conceived by a person of skill in the art with the aid of the present disclosure.

One skilled in the art will recognize that many types of data acquisition devices can be used in connection with the present invention, and that the invention is not limited to cameras. Thus, the use of the term “camera” herein is intended to be illustrative and exemplary, but should not be considered to limit the scope of the invention. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another.

### Architecture

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science.

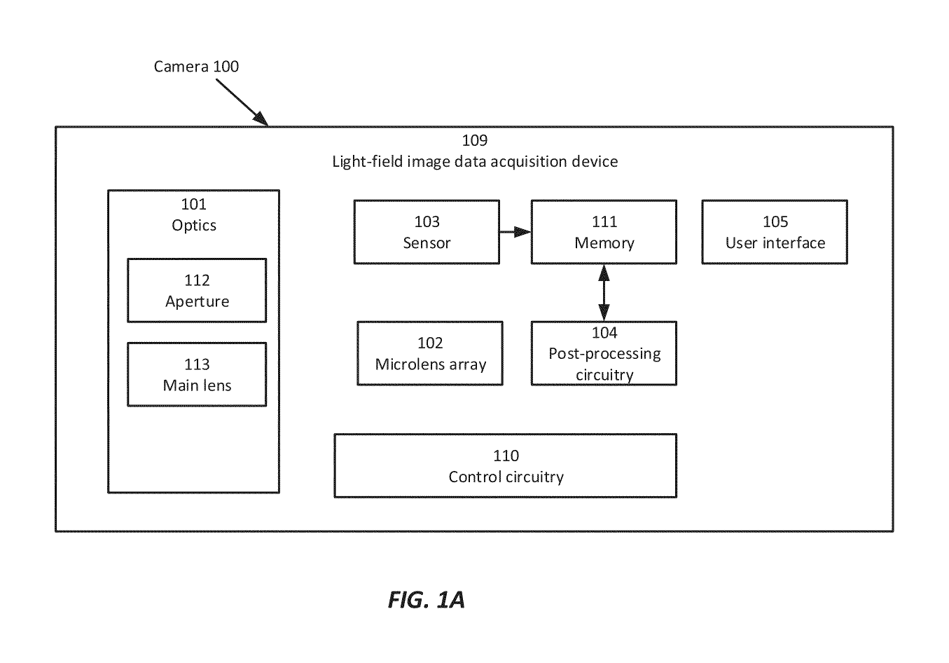

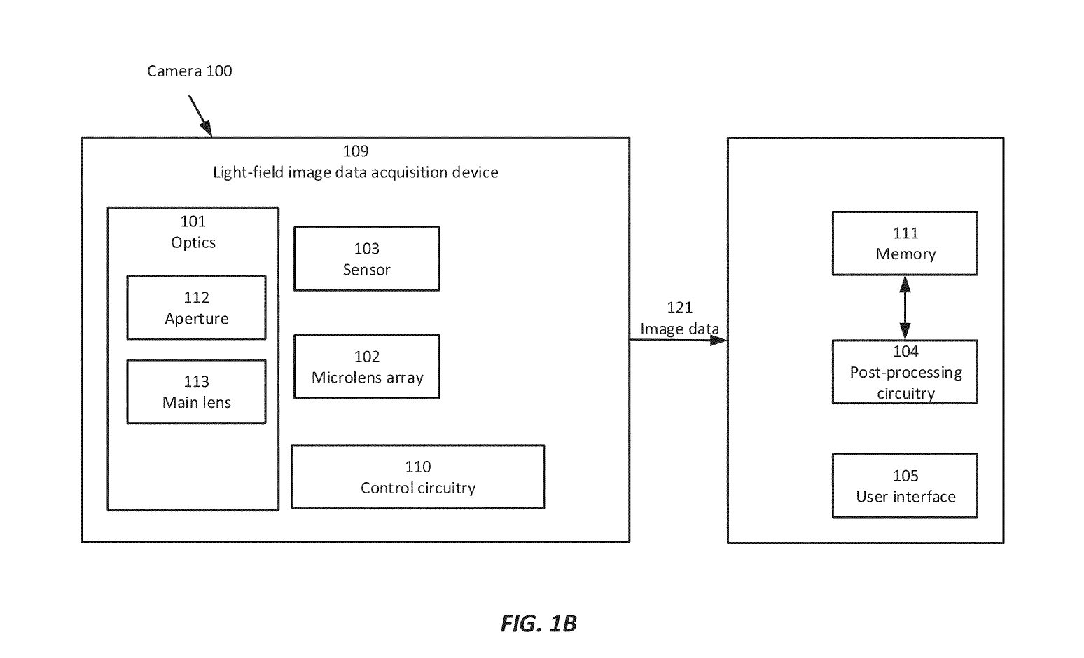

Referring now to FIG. 1A, there is shown a block diagram depicting an architecture for implementing the present invention in a light-field capture device such as a camera 100. Referring now also to FIG. 1B, there is shown a block diagram depicting an architecture for implementing the present invention in a post-processing system communicatively coupled to a light-field capture device such as a camera 100, according to one embodiment. One skilled in the art will recognize that the particular configurations shown in FIGS. 1A and 1B are merely exemplary, and that other architectures are possible for camera 100. One skilled in the art will further recognize that several of the components shown in the configurations of FIGS. 1A and 1B are optional, and may be omitted or reconfigured. Other components as known in the art may additionally or alternatively be added.

In at least one embodiment, camera 100 may be a light-field camera that includes light-field image data acquisition device 109 having optics 101, image sensor or sensor 103 (including a plurality of individual sensors for capturing pixels), and microlens array 102. Optics 101 may include, for example, aperture 112 for allowing a selectable amount of light into camera 100, and main lens 113 for focusing light toward microlens array 102. In at least one embodiment, microlens array 102 may be disposed and/or incorporated in the optical path of camera 100 (between main lens 113 and sensor 103) so as to facilitate acquisition, capture, sampling of, recording, and/or obtaining light-field image data via sensor 103.

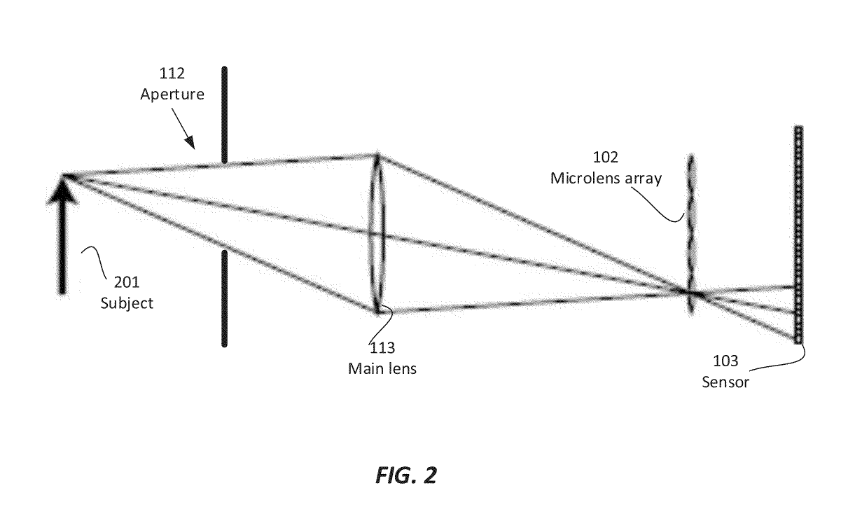

Referring now also to FIG. 2, there is shown an example of an architecture for a light-field camera, or a camera 100, for implementing the present invention according to one embodiment. The Figure is not shown to scale. FIG. 2 shows, in conceptual form, the relationship between aperture 112, main lens 113, microlens array 102, and sensor 103, as such components interact to capture light-field data for subject 201.

In at least one embodiment, camera 100 may also include a user interface 105 for allowing a user to provide input for controlling the operation of camera 100 for capturing, acquiring, storing, and/or processing image data.

In at least one embodiment, camera 100 may also include control circuitry 110 for facilitating acquisition, sampling, recording, and/or obtaining light-field image data. For example, control circuitry 110 may manage and/or control (automatically or in response to user input) the acquisition timing, rate of acquisition, sampling, capturing, recording, and/or obtaining of light-field image data.

In at least one embodiment, camera 100 may include memory 111 for storing image data, such as output by sensor 103. The memory 111 can include external and/or internal memory. In at least one embodiment, memory 111 can be provided at a separate device and/or location from camera 100. For example, camera 100 may store raw light-field image data, as output by sensor 103, and/or a representation thereof, such as a compressed image data file. In addition, as described in related U.S. Utility application Ser. No. 12/703,367 for “Light-field Camera Image, File and Configuration Data, and Method of Using, Storing and Communicating Same,” (Atty. Docket No. LYT3003), filed Feb. 10, 2010, memory 111 can also store data representing the characteristics, parameters, and/or configurations (collectively “configuration data”) of field image data acquisition device 109.

In at least one embodiment, captured image data is provided to post-processing circuitry 104. Such processing circuitry 104 may be disposed in or integrated into light-field image data acquisition device 109, as shown in FIG. 1A, or it may be in a separate component external to light-field image data acquisition device 109, as shown in FIG. 1B. Such separate component may be local or remote with respect to light-field image data acquisition device 109. The post-processing circuitry 104 may include a processor of any known configuration, including microprocessors, ASICS, and the like. Any suitable wired or wireless protocol can be used for transmitting image data 121 to processing circuitry 104; for example, the camera 100 can transmit image data 121 and/or other data via the Internet, a cellular data network, a Wi-Fi network, a Bluetooth communication protocol, and/or any other suitable means.

### Overview

Light-field images often include a plurality of projections (which may be circular or of other shapes) of aperture 112 of camera 100, each projection taken from a different vantage point on the camera's focal plane. The light-field image may be captured on sensor 103. The interposition of microlens array 102 between main lens 113 and sensor 103 causes images of aperture 112 to be formed on sensor 103, each microlens in the microlens array 102 projecting a small image of main-lens aperture 112 onto sensor 103. These aperture-shaped projections are referred to herein as disks, although they need not be circular in shape.

Light-field images include four dimensions of information describing light rays impinging on the focal plane of camera 100 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a four-dimensional (x,y,u,v) resolution of (400,300,10,10).

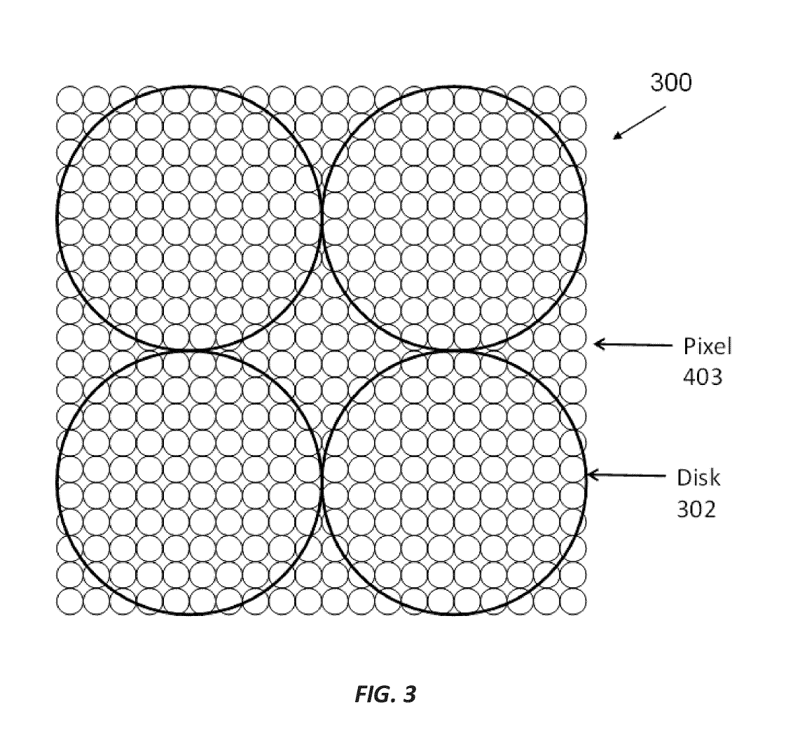

Referring now to FIG. 3, there is shown an example of a 2-disk by 2-disk portion 300 of such a light-field image, including depictions of disks 302 and individual pixels 403; for illustrative purposes, each disk 302 is ten pixels 403 across. Many light rays in the light-field within a light-field camera contribute to the illumination of a single pixel 403.

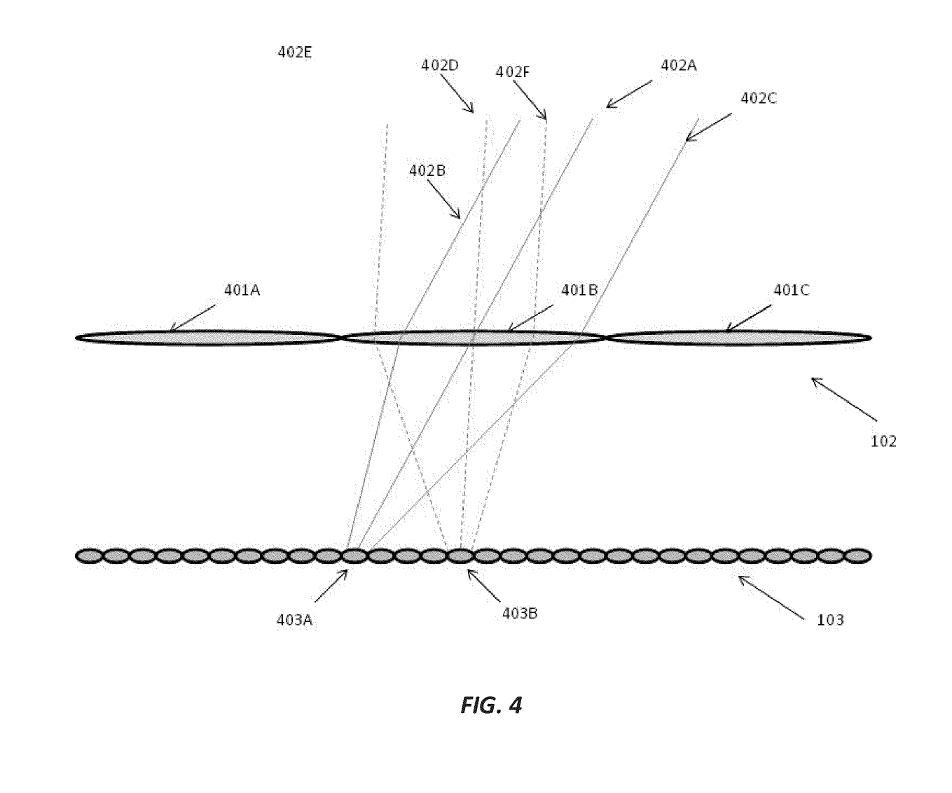

Referring now to FIG. 4, there is shown an example of transmission of light rays 402, including representative rays 402A, 402D, through microlens 401B of the microlens array 102, to illuminate sensor pixels 403A, 403B in sensor 103. In the example of FIG. 4, rays 402A, 402B, 402C (represented by solid lines) illuminate sensor pixel 403A, while dashed rays 402D, 402E, 402F illuminate sensor pixel 403B. The value at each sensor pixel 403 is determined by the sum of the irradiance of all rays 402 that illuminate it. For illustrative and descriptive purposes, however, it may be useful to identify a single geometric ray 402 with each sensor pixel 403. That ray 402 may be chosen to be representative of all the rays 402 that illuminate that sensor pixel 403, and is therefore referred to herein as a representative ray 402. Such representative rays 402 may be chosen as those that pass through the center of a particular microlens 401, and that illuminate the center of a particular sensor pixel 403. In the example of FIG. 4, rays 402A and 402D are depicted as representative rays; both rays 402A, 402D pass through the center of microlens 401B, with ray 402A representing all rays 402 that illuminate sensor pixel 403A and ray 402D representing all rays 402 that illuminate sensor pixel 403B.

There may be a one-to-one relationship between sensor pixels 403 and their representative rays 402. This relationship may be enforced by arranging the (apparent) size and position of main-lens aperture 112, relative to microlens array 102, such that images of aperture 112, as projected onto sensor 103, do not overlap.

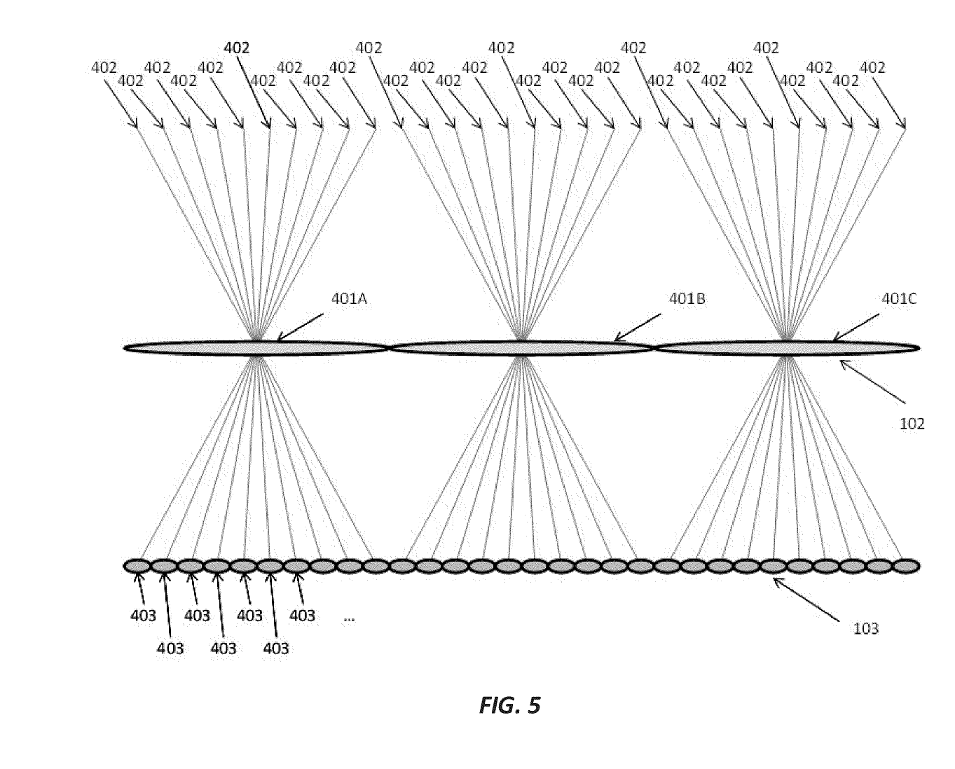

Referring now to FIG. 5, there is shown an example of an arrangement of a light-field capture device, such as camera 100, wherein microlens array 102 is positioned such that images of a main-lens aperture 112, as projected onto sensor 103, do not overlap. All rays 402 depicted in FIG. 5 are representative rays 402, as they all pass through the center of one of microlenses 401 to the center of a pixel 403 of sensor 103. In at least one embodiment, the four-dimensional light-field representation may be reduced to a two-dimensional image through a process of projection and reconstruction, as described in the above-cited patent applications.

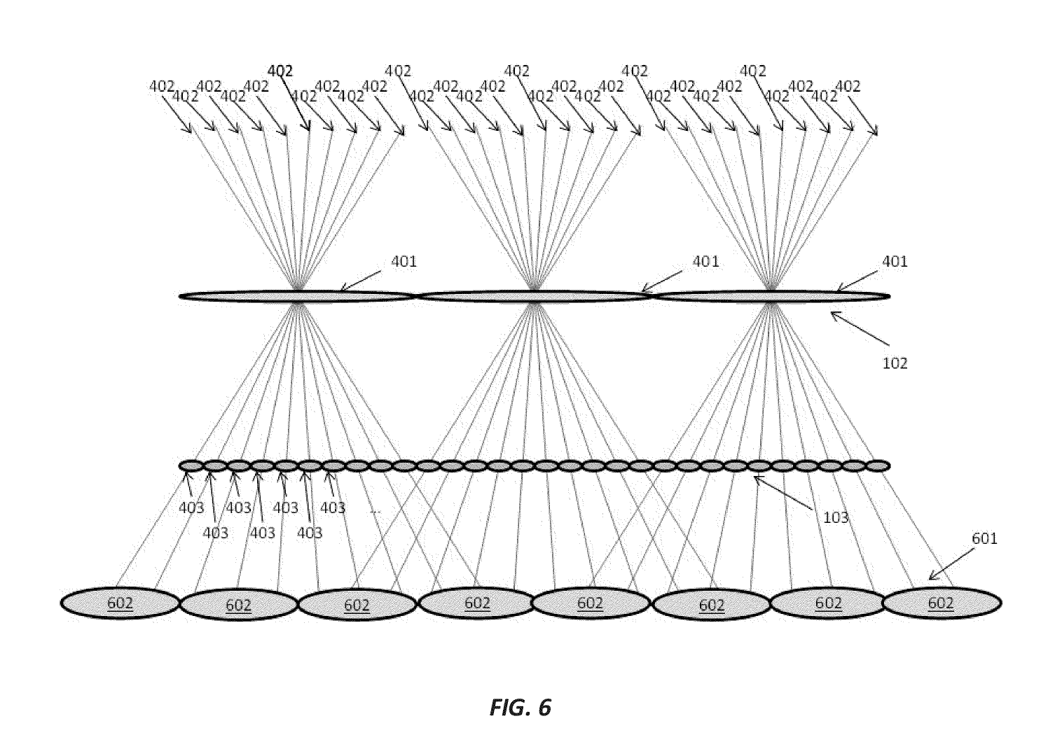

Referring now to FIG. 6, there is shown an example of such a process. A virtual surface of projection 601 may be introduced, and the intersection of each representative ray 402 with surface 601 may be computed. Surface 601 may be planar or non-planar. If planar, it may be parallel to microlens array 102 and sensor 103, or it may not be parallel. In general, surface 601 may be positioned at any arbitrary location with respect to microlens array 102 and sensor 103. The color of each representative ray 402 may be taken to be equal to the color of its corresponding pixel. In at least one embodiment, pixels 403 of sensor 103 may include filters arranged in a regular pattern, such as a Bayer pattern, and converted to full-color pixels. Such conversion can take place prior to projection, so that projected rays 402 can be reconstructed without differentiation. Alternatively, separate reconstruction can be performed for each color channel.

The color of an image pixel 602 on projection surface 601 may be computed by summing the colors of representative rays 402 that intersect projection surface 601 within the domain of that image pixel 602. The domain may be within the boundary of the image pixel 602, or may extend beyond the boundary of the image pixel 602. The summation may be weighted, such that different representative rays 402 contribute different fractions to the sum. Ray weights may be assigned, for example, as a function of the location of the intersection between ray 402 and surface 601, relative to the center of a particular pixel 602. Any suitable weighting algorithm can be used, including for example a bilinear weighting algorithm, a bicubic weighting algorithm and/or a Gaussian weighting algorithm.

### Two-Dimensional Image Processing

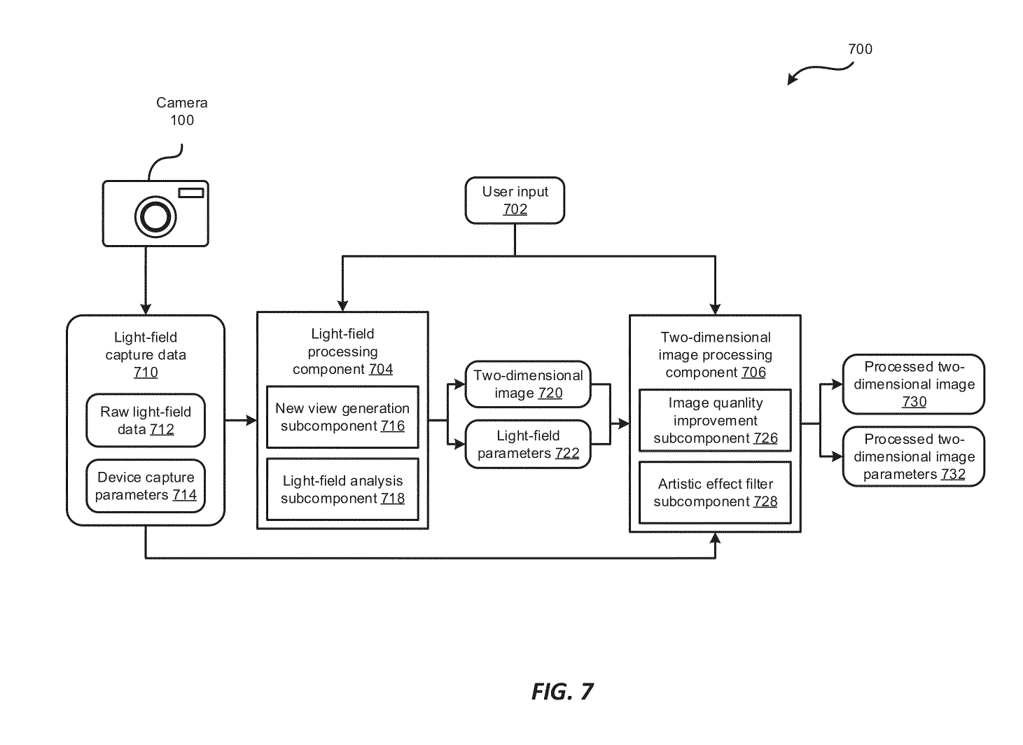

In at least one embodiment, two-dimensional image processing may be applied after projection and reconstruction. Such two-dimensional image processing can include, for example, any suitable processing intended to improve image quality by reducing noise, sharpening detail, adjusting color, and/or adjusting the tone or contrast of the picture. It can also include effects applied to images for artistic purposes, for example to simulate the look of a vintage camera, to alter colors in certain areas of the image, or to give the picture a non-photorealistic look, for example like a watercolor or charcoal drawing. This will be shown and described in connection with FIGS. 7-11, as follows.

### Image Processing Conceptual Architecture

FIG. 7 depicts an example of a system 700 for implementing the present invention according to one embodiment. The system 700 may include a light-field processing component 704 and a two-dimensional image processing component 706.

The light-field processing component 704 may process light-field capture data 710 received from the camera 100. Such light-field capture data 710 can include, for example, raw light-field data 712, device capture parameters 714, and the like. The light-field processing component 704 may process the raw light-field data 712 from the camera 100 to provide a two-dimensional image 720 and light-field parameters 722. The light-field processing component 704 may utilize the device capture parameters 714 in the processing of the raw light-field data 712, and may provide light-field parameters 722 in addition to the two-dimensional image 720. The light-field parameters 722 may be the same as the device capture parameters 714, or may be derived from the device capture parameters 714 through the aid of the light-field processing component 704.

Light-field processing component 704 can perform any suitable type of processing, such as generation of a new view (e.g. by refocusing and/or applying parallax effects) and/or light-field analysis (e.g. to determine per-pixel depth and/or depth range for the entire image). Thus, the light-field processing component 704 may have a new view generation subcomponent 716, a light-field analysis subcomponent 718, and/or any of a variety of other subcomponents that perform operations on the raw light-field data 712 to provide two-dimensional image 720.

If desired, user input 702 may be received by the light-field processing component 704 and used to determine the characteristics of the two-dimensional image 720. For example, the user input 702 may determine the type and/or specifications of the view generated by the new view generation subcomponent 716. In the alternative, the user input 702 may not be needed by the light-field processing component 704, which may rely, instead, on factory defaults, global settings, or the like in order to determine the characteristics of the two-dimensional image 720.

According to the techniques described herein, the two-dimensional image processing component 706 may perform two-dimensional image processing, taking into account any suitable parameters such as the device capture parameters 714 of the light-field capture data 710, the two-dimensional image 720 and light-field parameters 722 generated by the light-field processing component 704, and/or user input 702. These inputs can be supplied and/or used singly or in any suitable combination.

The output of the two-dimensional image processing component 706 may be a processed two-dimensional image 730, which may optionally be accompanied by processed two-dimensional image parameters 732, which may include any combination of parameters. The processed two-dimensional image parameters 732 may be the same as the light-field parameters 722 and/or the device capture parameters 714, or may be derived from the light-field parameters 722 and/or the device capture parameters 714 through the aid of the light-field processing component 704 and/or the two-dimensional image processing component 706.

The two-dimensional image processing component 706 can include functionality for performing, for example, image quality improvements and/or artistic effects filters. Thus, the two-dimensional image processing component 706 may have an image quality improvement subcomponent 726, an artistic effect filter subcomponent 728, and/or any of a variety of other subcomponents that perform operations on the two-dimensional image 720 to provide the processed two-dimensional image 730.

If desired, user input 702 may also be received by the two-dimensional image processing component 706 and used to determine the characteristics of the processed two-dimensional image 730. For example, the user input 702 may determine the type and/or degree of image enhancement to be applied by the image quality improvement subcomponent 726, and/or the type and/or settings of the artistic effect applied by the artistic effect filter subcomponent 728. In the alternative, the user input 702 may not be needed by the two-dimensional image processing component 706, which may rely, instead, on factory defaults, global settings, or the like in order to determine the characteristics of the processed two-dimensional image 730.

### Image Processing Methods

The most straightforward way to apply such image processing filters and effects may be to apply them the same way to all pictures produced from a given light-field. However, in at least one embodiment, image processing results may be improved, or new effects enabled, by adjusting the two-dimensional image processing based on one or more of: 1) parameters derived from the light-field, and/or 2) parameters describing the picture being generated from the light-field. Such parameters may include, for example and without limitation:
The target refocus depth for a picture refocused to a single depth.
The measured depth (lambda) value at a pixel. Per-pixel depth can be estimated by any suitable method, including for example the method described in related U.S. Utility application Ser. No. 13/027,946 for “3D Light-field Cameras, Images and Files, and Methods of Using, Operating, Processing and Viewing Same” (Atty. Docket No. LYT3006).
The per-pixel target refocus depth, in the case of extended depth-of-field (EDOF) pictures or pictures with non-planar virtual focal surfaces.
The difference between a target refocus depth and the measured depth at a pixel.
The click-to-focus depth value for a pixel. The click-to-focus depth is the depth selected for interactive refocusing when the user clicks a location in the image. This depth need not be the same as the measured lambda at that pixel.
The parameters specifying the center of perspective for a perspective view generated from the light-field. More specifically, for example, this can include the (u,v) coordinate specifying a center of perspective (COP) for COPs lying in the aperture of the light-field capture device aperture.

The above list is merely exemplary. One skilled in the art will recognize that any suitable combination of the above mentioned parameters and/or traditional two-dimensional image parameters such as (x,y) pixel location, pixel color or intensity, can be used. In addition, some parameters, such as refocus depth, click-to-focus depth, or view center of perspective, may be specified interactively by a user.

Any type of parameter(s) can be used as the basis for configuring two-dimensional image processing. Each parameter can be something that is deduced from the captured image, or it can be something that is explicitly specified, for example in metadata associated with the captured image. A parameter can also be specified by the user, either directly or indirectly; for example, the user can provide input that causes a parallax shift, which in turn affects a parameter that is used for configuring image processing.

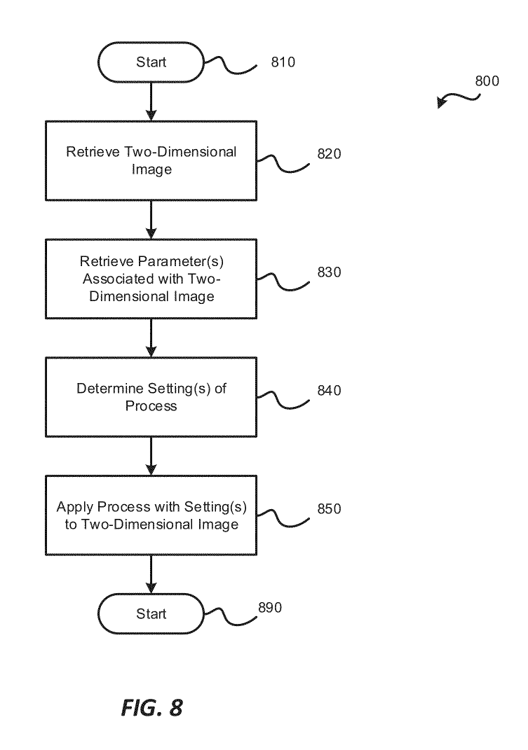

FIG. 8 illustrates a method 800 for utilizing parameters pertinent to a two-dimensional image captured from light-field data in the application of a process on the two-dimensional image 720. The method 800 is generalized, and is therefore applicable to a wide variety of image types, parameters, and processes. The method 800 may be performed by the two-dimensional image processing component 706 of FIG. 7, and/or by other components known in the art.

The method 800 may start 810 with a step 820 in which the two-dimensional image 720 is retrieved, for example, from the camera 100 or from the memory 111. The two-dimensional image 720 may first have been processed by the light-field processing component 704; hence, the two-dimensional image may optionally represent a new or refocused view generated from the light-field data 712 and/or a view generated after light-field analysis has taken place.

The method 800 may then proceed to a step 830 in which one or more light-field parameters 722 associated with the two-dimensional image 720 are also retrieved. The light-field parameters 722 may also be retrieved from the camera 100 or from the memory 111. The light-field parameters 722 may optionally be stored as metadata of the two-dimensional image 720. The two-dimensional image 720 and the light-field parameters 722 may be stored in any known type of file system, and if desired, may be combined into a single file.

Once the two-dimensional image 720 and the light-field parameters 722 have been retrieved, the method 800 may proceed to a step 840 in which the two-dimensional image processing component 706 determines the appropriate process setting to be applied to the two-dimensional image 720. This may be done through the use of the light-field parameters 722, which may contain a variety of data regarding the two-dimensional image 720, as set forth above. The two-dimensional image processing component 706 may engage in a variety of calculations, comparisons, and the like using the light-field parameters 722 to determine the most appropriate setting(s) to be applied to the process to be applied to the two-dimensional image 720. Examples of such calculations, comparisons, and the like will be provided subsequently.

Once the two-dimensional image processing component 706 has determined the most appropriate setting(s) for the process, the method 800 may proceed to a step 850 in which the process is applied to the two-dimensional image 720 with the setting(s) selected in the step 840. The result may be the processed two-dimensional image 730 and/or the processed two-dimensional image parameters 732. The processed two-dimensional image 730 may thus be an enhanced, artistically rendered, or otherwise altered version of the two-dimensional image 720. The method 800 may then end 890.

### Examples

A wide variety of processes may be applied to the two-dimensional image 720 in accordance with the present invention. The two-dimensional image processing component 706 may utilize different light-field parameters 722 to select the most appropriate settings for each process.

### Exemplary Parameters

In at least one embodiment, the system and method of the present invention may be implemented in connection with a light-field camera such as the camera 100 shown and described above and in the above-cited related patent applications. In at least one embodiment, the extracted parameters may be descriptive of such a light-field camera. Thus, the parameters can describe a state or characteristic of a light-field camera when it captures an image. For example, the parameters can specify the relationship (distance) between the image sensor and the MLA and/or the distance from the physical MLA plane to the virtual refocus surface.

In at least one embodiment, the parameters can describe properties of the generated picture (either individual pixels, or the entire picture) relative to the light-field camera itself. One example of such a parameter is the refocus lambda and measured lambda at each pixel, which may correspond to real distances above and below the MLA plane in the light-field capture device. In at least one embodiment, lambda (depth) may be a measure of distance from the MLA plane, in units of the MLA to sensor distance.

In at least one embodiment, light-field parameters can be combined with conventional camera parameters. For example, parameters can describe the zoom of the main lens and/or the field of view of the light-field sensor when it captures the light-field along with light-field parameters. Such parameters may be stored in association with the picture as metadata.

### Exemplary Two-Dimensional Image Processes

Any type of two-dimensional image processes can be configured based on light-field parameters to improve image quality. Such processes may include, for example and without limitation:
Noise filtering;
Sharpening;
Color adjustments; and
Tone curves, contrast adjustment, saturation adjustment, and/or gamma adjustment.

### Noise Reduction

Noise characterization is often used for state-of-the-art noise reduction. Characterizing the variation of noise with light-field parameters can improve the performance of noise reduction algorithms on images generated from light-fields. As described in related U.S. Utility application Ser. No. 13/027,946 for “3D Light-field Cameras, Images and Files, and Methods of Using, Operating, Processing and Viewing Same” (Atty. Docket No. LYT3006), the width of the reconstruction filter can vary with the target refocus lambda (for the in-focus reconstruction filter) and with the difference between the target refocus lambda and the measured lambda (for blended refocusing or the out-of-focus reconstruction filter). In general, if the reconstruction filter used in projection is wider, the output image may be less noisy, because more samples may be combined to produce each output pixel. If the reconstruction filter is narrower, the generated pictures may be noisier.

Noise filtering can be improved by generating noise profiles that are parameterized by target refocus lambda, or by the width of the in-focus and out-of-focus reconstruction filters for a given target refocus lambda. Additional improvement may be gained by configuring the noise filter to be stronger for target refocus lambdas corresponding to narrower reconstruction filters and weaker for target refocus lambdas corresponding to wider reconstruction filters.

It may also be useful to configure sharpening filters based on light-field parameters. One sharpening technique is the unsharp mask, which may amplify high-frequency detail in an image. The unsharp mask may subtract a blurred version of the image from itself to create a high-pass image, and then add some positive multiple of that high-pass image to the original image to create a sharpened image.

One known possible artifact of the unsharp mask is haloing, which refers to exaggerated, bright or dark thick edges where narrow high-contrast edges were present in the original image. Haloing can result from using a blur kernel that is too large relative to the high-frequency detail present in the image. For refocused light-field images, the maximum frequencies present in the projected image may vary with lambda, because the maximum sharpness of the refocused images varies with lambda.

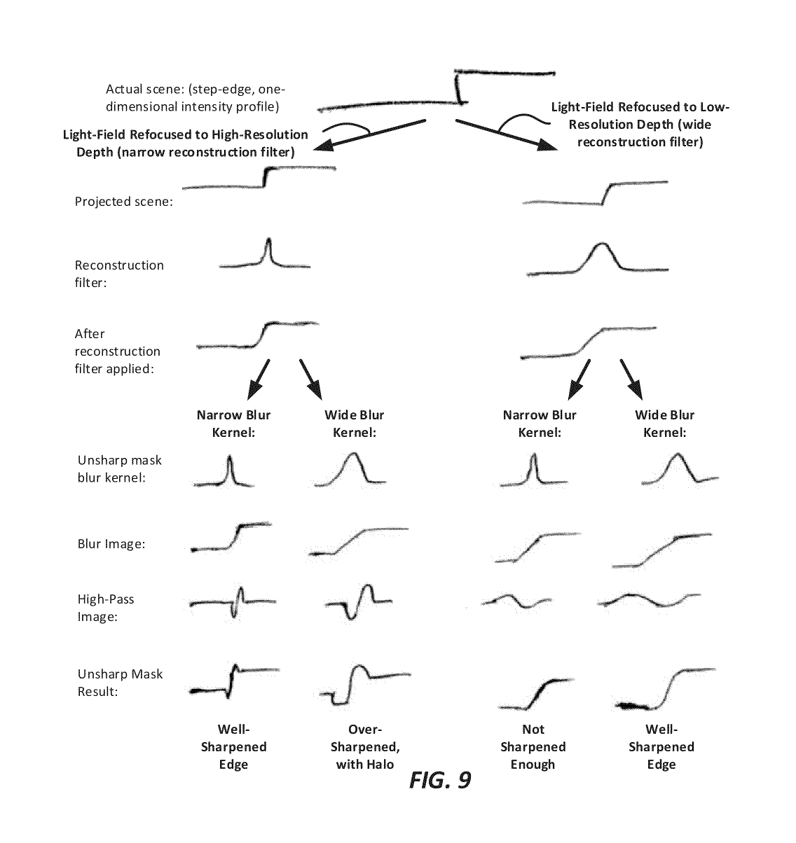

FIG. 9 illustrates an example of how the present invention may be used to select the settings for a reconstruction filter and an unsharp mask. At very high lambdas (i.e., above a high threshold) and near zero lambdas (i.e., below a low threshold), the reconstruction filter may be wide, which may prevent high-frequency detail from appearing in the image, as shown in the right side of the Figure. At peak resolution lambdas, the reconstruction filter may be narrow and the images can be sharper, as shown in the left side of the Figure. Thus, performance of the unsharp mask can be improved by using a narrow blur kernel when the reconstruction filter is narrow, and a wider blur kernel when the reconstruction filter is wide.

The left side of the Figure shows two examples of application of unsharp mask blur kernels after the narrow reconstruction filter is applied: a narrow blur kernel that results in a well-sharpened edge, and a wide blur kernel that causes over-sharpening and results in a halo artifact. The right side of the Figure shows two examples of application of unsharp mask blur kernels after the wide reconstruction filter is applied: a narrow blur kernel that results in insufficient sharpening, and a wide blur kernel that provides better sharpening. This example illustrates the benefit of adjusting or configuring the blur kernel according to lambda, because lambda may be a determiner of the degree of high-frequency detail in the image.

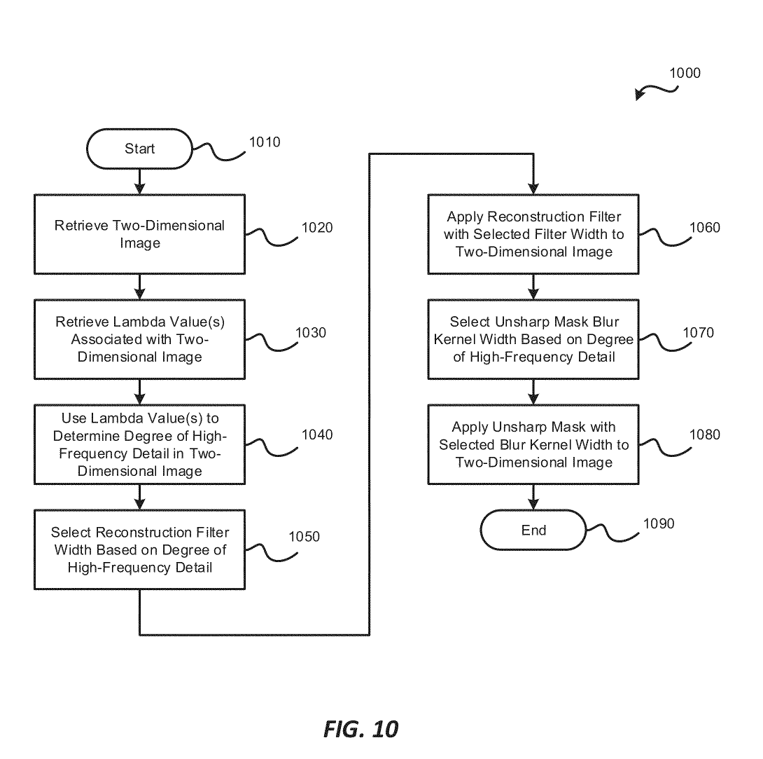

FIG. 10 illustrates a method 1000 that is a more specific version of the method 800, with application to an unsharp mask to be applied to the two-dimensional image 720. The method 1000 may start 1010 with a step 1020 in which the two-dimensional image 720 is retrieved, for example, from the camera 100 or the memory 111. In a step 1030, the lambda value(s) associated with the two-dimensional image 720 may be retrieved, for example, from the camera 100 or the memory 111.

The method 1000 may then proceed to a step 1040 in which the lambda value(s) are used to determine the degree of high-frequency detail that is present in the two-dimensional image 720, or in any part of the two-dimensional image 720. A very high or very low lambda value (e.g., above a high threshold or below a low threshold) may lead to the conclusion that the two-dimensional image 720, or the portion under consideration, has a low resolution and/or relatively little high-frequency detail. Conversely, a lambda value between the low and high thresholds may lead to the conclusion that the two-dimensional image 720, or the portion under consideration, has a high resolution and/or relatively large amount of high-frequency detail.

The method 1000 may then proceed to a step 1050 in which the width of a reconstruction filter applied to the two-dimensional image 720 is determined based on the level of high-frequency detail present in the two-dimensional image 720. For example, if little high-frequency detail is present, a wide reconstruction filter may be selected. Conversely, if a large amount of high-frequency detail is present, a narrow reconstruction filter may be selected.

After the reconstruction filter width has been established, the method 1000 may proceed to a step 1060 in which the reconstruction filter is applied with the selected width. Thus, a wide reconstruction filter may be applied as on the right-hand side of FIG. 9, or a narrow reconstruction filter may be applied as on the left-hand side of FIG. 9.

After the reconstruction filter has been applied, the method 1000 may proceed to a step 1070 in which the blur kernel width of an unsharp mask is selected based on the level of high-frequency detail present in the two-dimensional image 720. For example, if little high-frequency detail is present, a wide blur kernel may be selected. Conversely, if a large amount of high-frequency detail is present, a narrow blur kernel may be selected.

After the blur kernel width has been established, the method 1000 may proceed to a step 1080 in which the unsharp mask is applied with the selected blur kernel. Thus, a wide blur kernel may be applied as on the far right column toward the bottom of FIG. 9, or a narrow reconstruction filter may be applied as on the far left column toward the bottom of FIG. 9.

The adjustment to blur kernel width can be determined from theory or empirically. The adjustment can be made on a per-image basis according to the target refocus lambda, or even on a per-pixel basis. One can also tune the unsharp mask parameter commonly called “amount” (which specifies the multiple of the high-pass image added to the original image) based on lambda. For example, at lambda for which the unsharp mask radius is set to be relatively narrow, increasing the unsharp mask amount can produce better results.

In at least one embodiment, the best blur radius and unsharp amount can be empirically determined as a function of refocus depth. For example, a sweep of light-field images of a planar pattern with a step edge can be captured and used as calibration light-field data to provide a calibration image; this can be, for example, a light gray square adjacent to a dark gray square. The focus of the sensor may vary such that the measured depth (the measured “lambda” value, or depth from the light-field sensor plane) of the target changes gradually from a large negative value to a large positive value. In other words, the image of the target produced by the main lens may be focused below the light-field sensor at the start of the sweep and above the sensor at the end (or vice versa), and may vary in small steps from one to the other across the sweep. Each light-field image may be refocused to provide a processed two-dimensional calibration image in which the target is in focus, and the unsharp mask radius and unsharp mask amount for that lambda may be chosen to maximize perceived sharpness while minimizing halo artifacts.

The result may be a set of unsharp mask parameters corresponding to specific lambda values. These parameters may then be used to automatically configure the unsharp mask when refocusing other light-field images. The configuration can specify that the unsharp mask parameters from the nearest lambda value should be used in the sweep; alternatively, more sophisticated methods such as curve fitting can be used to interpolate parameters between lambda values in the empirical data set.

According to various embodiments, the unsharp mask parameters for a refocused image can be configured in any of a number of ways. For example and without limitation:
If the entire image is refocused to a single depth, the parameters for that refocus depth can be used for the entire image. This may result in objects in focus at that depth being sharpened well, with minimal halo artifacts. Out of focus objects may be blurred by the refocusing, and thus may be sharpened less and may therefore be unlikely to create halo artifacts.
Another option for an image refocused to a single depth is to vary the unsharp mask parameters based on the target refocus depth and the measured refocus depth at each pixel. Empirically determined parameters for the target refocus depth can be used for pixels whose measured depth is at or near the target depth. For pixels whose measured depth is not at the target depth, a larger blur radius (and possibly smaller unsharp amount) can be used. This may add lower frequency information to the unsharp mask high pass image at out-of-focus pixels and may sharpen the out-of-focus area more, increasing the apparent sharpness of the entire image.
For EDOF images, the reconstruction filter can be varied per-pixel based on the measured depth at that output pixel, and the blur kernel width at that pixel can be configured based on the measured lambda.

### Two-Dimensional Image Effects or “Post-Filters”

Two-dimensional image processing used for artistic effects can also be improved using configuration based on light-field parameters, including for example any of the parameters discussed above. In at least one embodiment, light-field parameters that specify the viewing parameters can be used to configure such effects. The viewing conditions can be static, or, in the case of an interactive viewing application, dynamic.

In another embodiment, viewing parameters relative to the main lens of a light-field camera can be used; for example, parameters specifying the view center of perspective relative to a light-field capture device's main aperture can be used.

In another embodiment, color at each pixel can be altered based on “defocus degree” (the difference between the target refocus depth and the measured depth). For example, pixels can be desaturated (blended toward grayscale) according to defocus degree. Pixels corresponding to objects that are in focus at the target refocus depth may be assigned their natural color, while pixels corresponding to defocused objects may approach grayscale as the defocus degree increases in magnitude. As another example, saturation can be increased for in-focus regions.

Many other effects are possible. In at least one embodiment, non-photorealistic rendering techniques can be configured based on light-field parameters. Examples include, without limitation:
Magnify in-focus regions and contract defocused regions in the refocused image. This causes objects to appear to grow when they are in focus and shrink when they are out of focus.
Render the output image as an artistic simulation, such as rendering the image as if drawn in water color, or an oil painting, but with the brush stroke size larger for defocused regions and smaller for in-focus regions, or smaller in areas with larger measured depth and larger in areas with lower measured depth.
A stippling filter that uses larger stipples in regions of greater defocus degree.
Create an EDOF image, choose a target refocus depth, and apply a strong edge-preserving smoothing filter with radius that increases with defocus degree. This may create an edge-preserving defocus effect.

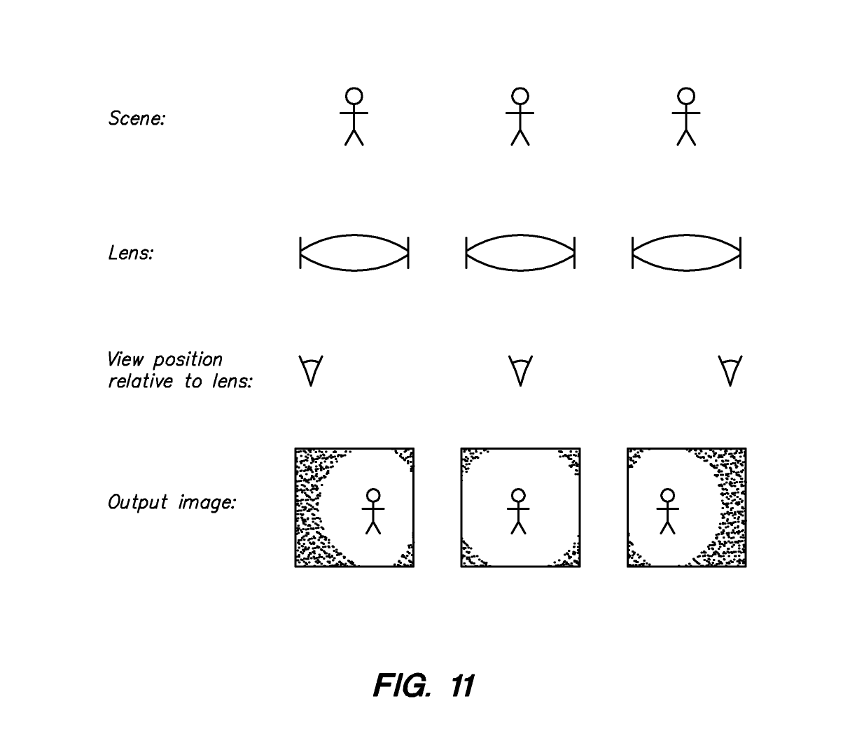

In at least one embodiment, artistic effects can be configured based on parameters describing the center of perspective of the view rendered from a light-field. Examples include, without limitation:
A filter that simulates lens shading or vignetting that varies based on the perspective view parameters. These parameters can be made relative to the main lens. This may simulate the experience of looking through some lenses directly along their optical axis or from off the axis. As the view position (i.e., the viewpoint) changes, portions of the field of view may become blocked. In at least one embodiment, the effect can be parameterized based on the (u,v) coordinate of a parallax view (or subaperture view).
   An example of such a vignetting lens effect is shown in FIG. 11. Here, the edge of the field of view may be restricted (blocked) as one moves to the side, as if one were using a lens with vignetting. For illustrative purposes, the lens is shown as a single element; however, one skilled in the art will recognize that the lens can be a multi-element lens.
   For parallax viewing, objects in the scene may show parallax. Vignetting can be combined with parallax to reinforce the sense of using a physical camera. The effect need not be physically accurate to be compelling.
   In at least one embodiment, the effect may be implemented by shifting a cosine falloff based on the view coordinates, as follows:
      Define the following variables:
         (x,y)=the output image pixel coordinate
         width=the width of the output image
         height=the height of the output image
         (u,v) is the coordinates of the perspective view, expressed as a coordinate lying with the two-dimensional circle of radius 0.5. The circle may represent the lens aperture, and the (u,v) coordinates may be the same used to specify a subaperture view.

K=0.5*sqrt(0.5*(width*width+height*height))
(r,g,b) is the pixel color value
(r′,g′,b′) is the pixel color value after the vignetting is applied
Use the following calculation at each pixel in a rendered image:

xOffset=uCoord*(width/2.0)

yOffset=vCoord*(height/2.0)

xdist=xOffset+x−(width/2)

ydist=yOffset+y−(height/2)

radius=sqrt(xdist*xdist+ydist*ydist)/k

shading=max(cos(radius),0.0)

(r′,g′,b′)=(shading*r,shading*g,shading*b)
A filter that simulates focus breathing when refocusing a light-field. “Focus breathing” is the magnification or reduction that accompanies changing focus in some lens systems. In at least one embodiment, this effect may be implemented as follows:
   Determine the range of allowed refocus depths in the light-field. For example, this can be the range of target refocus depths in a refocus stack.
   Compute a function k=scale(refocus_lambda) that maps refocus lambda to k, the factor by which to magnify the image content. Set this function to be 1.0 for the refocus depth furthest from the camera, and to increase monotonically for refocus depths closer to the camera. One choice is a linear function from 1.0 at the furthest depth to 1.1 at the nearest depth, with both depths expressed relative to the light-field sensor plane (i.e. in lambda). The linear mapping may be a good approximation to actual focus breathing.
   Magnify the contents of each output image by scale(refocus_lambda) without changing the output image resolution. This means objects in the scene may appear larger and the field of view of magnified images may decrease. The closer the refocus depth, the greater the magnification.
   Note: setting the scale factor >1.0 for all possible refocus lambdas may be advantageous if the filter is applied to a refocus stack, because no image may be minified. Minification may increase the field of view, requiring data not present in the stack of images.

In at least one embodiment, a sepia tone filter, the vignetting filter described above, and/or the focus breathing filter described above can be combined with one another in any suitable way. In at least one embodiment, filters can be applied to every image in a refocus stack, or to every image in a parallax stack, or both.

### Depth-Based Brightness Compensation

In at least one embodiment, depth and/or other parameters can be used as a basis for adjusting image gain, so as to compensate for variations in image brightness based on determined depth (lambda). In at least one embodiment, the image gain adjustment can be configured based on a scene illumination model. Thus, a scene-based depth map can be used as a configuration parameter for metering of the image. Localized gain can be applied as the distance changes between one or more subjects and the flash light source.

In at least one embodiment, the gain can be applied in real-time in the sensor of the image capture apparatus; alternatively, it can be applied during post processing. The quality of sensor-based localized gain may vary depending on the minimum pixel group size for which the sensor can independently adjust gain. Alternatively, localized gain adjustment during post processing can be done at the individual pixel level, and can be scaled in complexity according to available processing power. If done in post-processing, localized gain adjustment may not require sensor hardware changes, but may be subject to depth map quality and processing horsepower.

In at least one embodiment, depth-based brightness compensation can be implemented using high dynamic range (HDR) CMOS sensors with split-pixel designs, wherein each pixel is split into two sub-pixels with different well capacities. Light rays from closer subjects can be recorded on the smaller pixels, while light rays from more distant objects can be recorded on the larger pixels.

In at least one embodiment, a scene-based depth map can be used as a configuration parameter for the intensity and/or direction of one or more supplemental lighting devices. For example such a depth map may be used to determine whether a camera flash and/or one or more external flashes should be on or off, to improve the image exposure. In at least one embodiment, flash intensity can be adjusted to achieve optimal exposure as objects with various depths are presented within a given scene.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

In various embodiments, the present invention can be implemented as a system or a method for performing the above-described techniques, either singly or in any combination. In another embodiment, the present invention can be implemented as a computer program product comprising a nontransitory computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in at least one embodiment” in various places in the specification are not necessarily all referring to the same embodiment.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention include: a mobile phone, personal digital assistant, smartphone, kiosk, server computer, enterprise computing device, desktop computer, laptop computer, tablet computer, consumer electronic device, television, set-top box, or the like. An electronic device for implementing the present invention may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method for processing a two-dimensional image projected from light-field data, comprising:
at a processor, retrieving a two-dimensional image projected from light-field data;
at the processor, retrieving at least one parameter associated with the two-dimensional image;
at the processor, based on the parameter, determining a first setting of a process; and
at the processor, applying the process with the first setting to the two-dimensional image to generate a processed two-dimensional image.

2. The method of claim 1, wherein the parameter describes the picture being generated from the light-field.

3. The method of claim 1, wherein the parameter is derived from the light-field data.

4. The method of claim 3, wherein the process comprises a non-photorealistic rendering technique selected from the group consisting of:
a magnification process by which an in-focus region of the two-dimensional image is magnified relative to a defocused region of the two-dimensional image;
an artistic simulation process by which the two-dimensional image is modified to simulate a painting with a brush stroke size that is larger in a defocused region of the two-dimensional image than in a focused region of the two-dimensional image;
a stippling filter that uses larger stipples in a defocused region of the two-dimensional image than in a focused region of the two-dimensional image; and
an edge-preserving smoothing filter with a larger radius in a defocused region of the two-dimensional image than in a focused region of the two-dimensional image.

5. The method of claim 1, wherein the process is selected from the group consisting of:
a noise filtering process;
an image sharpening process;
a color adjustment process;
a tone curve process;
a contrast adjustment process;
a saturation adjustment process; and
a gamma adjustment process.

6. The method of claim 1, wherein the parameter is selected from the group consisting of:
a target refocus depth applicable to the entire two-dimensional image;
a measured lambda value at a pixel of the two-dimensional image, wherein the lambda value indicates a distance perpendicular to a microlens array of a light-field capture device used to capture the light-field data;
a difference between the measured lambda and a target refocus depth at a pixel of the two-dimensional image; and
a click-to-focus depth value at a pixel of the two-dimensional image, wherein the click-to-focus depth value comprises a depth selected by a user for interactive refocusing of the two-dimensional image.

7. The method of claim 6, wherein the parameter comprises a measured lambda value at a pixel of the two-dimensional image, wherein the lambda value indicates a distance perpendicular to a microlens array of a light-field capture device used to capture the light-field data, and wherein the process comprises an image gain adjustment process that adjusts brightness of the pixel based on the lambda value.

8. The method of claim 6, wherein the parameter comprises a measured lambda value at a pixel of the two-dimensional image, wherein the lambda value indicates a distance perpendicular to a microlens array of a light-field capture device used to capture the light-field data, wherein the method further comprises:
using the parameter to determine a degree of high-frequency detail in the two-dimensional image;
and wherein the first setting is determined based the degree of high-frequency detail.

9. The method of claim 8, wherein using the parameter to determine a degree of high-frequency detail in the two-dimensional image comprises:
above a high threshold or below a low threshold, determining that the pixel has relatively little high-frequency detail; and
responsive to the lambda value at the pixel being above the low threshold and below the high threshold, determining that the pixel has a relatively higher amount of high-frequency detail.

10. The method of claim 1, wherein the parameter comprises a center-of-perspective parameter, wherein the process is selected from the group consisting of:
a vignetting filter that modifies the two-dimensional image to simulate changes in viewpoint when looking through a lens; and
a focus breathing filter that modifies the two-dimensional image to simulate magnification and/or reduction as a focus of a lens system is adjusted.

11. The method of claim 1, wherein the two-dimensional image comprises metadata comprising the parameter.

12. The method of claim 1, further comprising, prior to applying the process to the two-dimensional image:
at the processor, applying a reconstruction filter to the two-dimensional image to reduce aliasing artifacts of the two-dimensional image and/or increase sharpness of the two-dimensional image.

13. The method of claim 12, wherein the process comprises a noise filter, wherein applying the process to the two-dimensional image comprises reducing a noise level of the processed two-dimensional image.

14. The method of claim 13, wherein the noise filter comprises an unsharp mask, wherein the first setting comprises a blur kernel width of the unsharp mask, wherein determining the first setting comprises:
if the reconstruction filter used a low width, selecting a low width for the blur kernel; and
if the reconstruction filter used a high width, selecting a high width for the blur kernel.

15. The method of claim 14, further comprising:
based on the parameter, determining a second setting of the process;
and wherein the second setting comprises an unsharp amount of the unsharp mask, wherein the unsharp amount comprises a multiple of a high-pass image to be added to the two-dimensional image.

16. The method of claim 1, wherein the first setting is applicable to all pixels of the two-dimensional image, wherein applying the process to the two-dimensional image comprises applying the process with the first setting to all pixels of the two-dimensional image.

17. The method of claim 1, further comprising:
based on the parameter, determining a second setting of the process;
and wherein applying the process to the two-dimensional image comprises:
applying the process with the first setting to a first pixel of the two-dimensional image; and
applying the process with the second setting to a second pixel of the two-dimensional image.

18. The method of claim 17, wherein the two-dimensional image comprises an extended depth-of-field (EDOF) image comprising a non-planar virtual focal surface.

19. The method of claim 1, further comprising, prior to retrieving the two-dimensional image:
retrieving a two-dimensional calibration image projected from calibration light-field data;
performing the method on the two-dimensional calibration image with a plurality of values of the first setting to generate a processed two-dimensional calibration image; and
using the processed two-dimensional calibration image to determine which of the plurality values of the first setting should be used with each of a plurality of values of the parameter.

20. A computer program product for processing a two-dimensional image projected from light-field data, comprising:
a non-transitory computer-readable storage medium; and
computer program code, encoded on the medium, configured to cause at least one processor to perform the steps of:
retrieving a two-dimensional image projected from light-field data;
retrieving at least one parameter associated with the two-dimensional image;
based on the parameter, determining a first setting of a process; and
applying the process with the first setting to the two-dimensional image to generate a processed two-dimensional image.

21. The computer program product of claim 20, wherein the parameter describes the picture being generated from the light-field.

22. The computer program product of claim 20, wherein the parameter is derived from the light-field data.

23. The computer program product of claim 22, wherein the process comprises a non-photorealistic rendering technique selected from the group consisting of:
a magnification process by which an in-focus region of the two-dimensional image is magnified relative to a defocused region of the two-dimensional image;
an artistic simulation process by which the two-dimensional image is modified to simulate a painting with a brush stroke size that is larger in a defocused region of the two-dimensional image than in a focused region of the two-dimensional image;
a stippling filter that uses larger stipples in a defocused region of the two-dimensional image than in a focused region of the two-dimensional image; and
an edge-preserving smoothing filter with a larger radius in a defocused region of the two-dimensional image than in a focused region of the two-dimensional image.

24. The computer program product of claim 20, wherein the process is selected from the group consisting of:
a noise filtering process;
an image sharpening process;
a color adjustment process;
a tone curve process;
a contrast adjustment process;
a saturation adjustment process; and
a gamma adjustment process.

25. The computer program product of claim 20, wherein the parameter is selected from the group consisting of:
a target refocus depth applicable to the entire two-dimensional image;
a measured lambda value at a pixel of the two-dimensional image, wherein the lambda value indicates a distance perpendicular to a microlens array of a light-field capture device used to capture the light-field data;
a difference between the measured lambda and a target refocus depth at a pixel of the two-dimensional image; and
a click-to-focus depth value at a pixel of the two-dimensional image, wherein the click-to-focus depth value comprises a depth selected by a user for interactive refocusing of the two-dimensional image.

26. The computer program product of claim 25, wherein the parameter comprises a measured lambda value at a pixel of the two-dimensional image, wherein the lambda value indicates a distance perpendicular to a microlens array of a light-field capture device used to capture the light-field data, and wherein the process comprises an image gain adjustment process that adjusts brightness of the pixel based on the lambda value.

27. The computer program product of claim 25, wherein the parameter comprises a measured lambda value at a pixel of the two-dimensional image, wherein the lambda value indicates a distance perpendicular to a microlens array of a light-field capture device used to capture the light-field data, and wherein the computer program code is further configured to cause the processor to perform the step of:
using the parameter to determine a degree of high-frequency detail in the two-dimensional image;
wherein the first setting is determined based the degree of high-frequency detail;
and wherein using the parameter to determine a degree of high-frequency detail in the two-dimensional image comprises:
responsive to the lambda value at the pixel being above a high threshold or below a low threshold, determining that the pixel has relatively little high-frequency detail; and
responsive to the lambda value at the pixel being above the low threshold and below the high threshold, determining that the pixel has a relatively higher amount of high-frequency detail.

28. The computer program product of claim 20, wherein the computer program code is further configured to cause the processor to perform the step of:
applying a reconstruction filter to the two-dimensional image to reduce aliasing artifacts of the two-dimensional image and/or increase sharpness of the two-dimensional image;
wherein the process comprises a noise filter;
and wherein applying the process to the two-dimensional image comprises reducing a noise level of the processed two-dimensional image.

29. The computer program product of claim 20, wherein the computer program code is further configured to cause the processor to perform the step of:
based on the parameter, determining a second setting of the process;
and wherein applying the process to the two-dimensional image comprises:
applying the process with the first setting to a first pixel of the two-dimensional image; and
applying the process with the second setting to a second pixel of the two-dimensional image.

30. A system for processing a two-dimensional image projected from light-field data, comprising:
a processor configured to:
retrieve a two-dimensional image projected from light-field data;
retrieve at least one parameter associated with the two-dimensional image;
based on the parameter, determine a first setting of a process; and
apply the process with the first setting to the two-dimensional image to generate a processed two-dimensional image.

31. The system of claim 30, wherein the parameter describes the picture being generated from the light-field.

32. The system of claim 30, wherein the parameter is derived from the light-field data.

33. The system of claim 32, wherein the process comprises a non-photorealistic rendering technique selected from the group consisting of:
a magnification process by which an in-focus region of the two-dimensional image is magnified relative to a defocused region of the two-dimensional image;
an artistic simulation process by which the two-dimensional image is modified to simulate a painting with a brush stroke size that is larger in a defocused region of the two-dimensional image than in a focused region of the two-dimensional image;
a stippling filter that uses larger stipples in a defocused region of the two-dimensional image than in a focused region of the two-dimensional image; and
an edge-preserving smoothing filter with a larger radius in a defocused region of the two-dimensional image than in a focused region of the two-dimensional image.

34. The system of claim 30, wherein the process is selected from the group consisting of:
a noise filtering process;
an image sharpening process;
a color adjustment process;
a tone curve process;
a contrast adjustment process;
a saturation adjustment process; and
a gamma adjustment process.

35. The system of claim 30, wherein the parameter is selected from the group consisting of:
a target refocus depth applicable to the entire two-dimensional image;
a measured lambda value at a pixel of the two-dimensional image, wherein the lambda value indicates a distance perpendicular to a microlens array of a light-field capture device used to capture the light-field data;
a difference between the measured lambda and a target refocus depth at a pixel of the two-dimensional image; and
a click-to-focus depth value at a pixel of the two-dimensional image, wherein the click-to-focus depth value comprises a depth selected by a user for interactive refocusing of the two-dimensional image.

36. The system of claim 35, wherein the parameter comprises a measured lambda value at a pixel of the two-dimensional image, wherein the lambda value indicates a distance perpendicular to a microlens array of a light-field capture device used to capture the light-field data, and wherein the process comprises an image gain adjustment process that adjusts brightness of the pixel based on the lambda value.

37. The system of claim 35, wherein the parameter comprises a measured lambda value at a pixel of the two-dimensional image, wherein the lambda value indicates a distance perpendicular to a microlens array of a light-field capture device used to capture the light-field data, wherein the processor is further configured to:
use the parameter to determine a degree of high-frequency detail in the two-dimensional image;
wherein the first setting is determined based the degree of high-frequency detail;
and wherein using the parameter to determine a degree of high-frequency detail in the two-dimensional image comprises:
responsive to the lambda value at the pixel being above a high threshold or below a low threshold, determining that the pixel has relatively little high-frequency detail; and
responsive to the lambda value at the pixel being above the low threshold and below the high threshold, determining that the pixel has a relatively higher amount of high-frequency detail.

38. The system of claim 30, wherein processor is further configured to:
apply a reconstruction filter to the two-dimensional image to reduce aliasing artifacts of the two-dimensional image and/or increase sharpness of the two-dimensional image;
wherein the process comprises a noise filter;
and wherein applying the process to the two-dimensional image comprises reducing a noise level of the processed two-dimensional image.

39. The system of claim 30, wherein the processor is further configured to:
based on the parameter, determine a second setting of the process;
and wherein applying the process to the two-dimensional image comprises:
applying the process with the first setting to a first pixel of the two-dimensional image; and
applying the process with the second setting to a second pixel of the two-dimensional image.
